(19) United States
(12) Patent Application Publication
(10) Pub. No.: US 2024/0354899 A1
(43) Pub. Date: Oct. 24, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Yuta HORIKAWA, Tokyo (JP)

(21) Appl. No.: 18/629,989

(22) Filed: Apr. 9, 2024

(30) Foreign Application Priority Data
Apr. 18, 2023 (JP) 2023-067793

(51) Int. Cl. G06T 5/50; G06T 5/70

(52) U.S. Cl. CPC G06T 5/50; G06T 5/70; G06T 2207/20016; G06T 2207/20212

(57) ABSTRACT

In order to improve image quality while suppressing a reduction in processing speed, in an information processing apparatus, at least one high-resolution feature quantity is generated for an input image, a low-resolution feature quantity of a lower resolution than the high-resolution feature quantity is generated, attention processing is selectively executed on the low-resolution feature quantity, and the high-resolution feature quantity and the low-resolution feature quantity are combined, and an image to which predetermined image processing has been applied is generated.

### BACKGROUND OF THE INVENTION

### Field of the Invention

The present invention relates to an information processing apparatus, an information processing method, a storage medium, and the like.

### Description of the Related Art

In recent years, in the field of image processing technology for enhancing image quality, methods using neural networks have been actively developed. For example, high-quality image processing such as noise reduction, blur removal, and super-resolution is realized by using neural networks. One of the elements proposed for configuring a neural network is an attention mechanism.

When feature quantities are input, the attention mechanism generates weights for these feature quantities, and by using the generated weights, the attention mechanism realizes attention processing that emphasizes important elements in the feature quantities.

By introducing this attention mechanism into a neural network, it is possible to improve the performance of various image processing tasks, including the above-described high-quality image processing tasks, thereby enhancing image quality.

As disclosed in Non-Patent Literature 1 (“Frequency Attention Network: Blind Noise Removal for Real Images”, Hongcheng Mo, et. al., 2020), neural networks that realize high-quality image processing generally have a structure such that they first generate feature quantities while compressing the input image, and then obtain the desired image processing results while restoring the compressed feature quantities to the original resolution. At this time, by performing attention processing on the compressed feature quantities, these networks acquire better feature quantities and thereby enhance image quality.

However, the introduction location of the attention mechanism in neural networks for realizing high-quality image processing has not been adequately considered. In networks like those disclosed in Non-Patent Literature 1, which always execute attention processing after generating multiple compressed feature quantities, there is a problem that processing speed significantly decreases due to redundant attention mechanisms that do not contribute to the improvement of image quality.

### SUMMARY OF THE INVENTION

One aspect of the present invention is an information processing apparatus comprising at least one processor and a memory coupled to the at least one processor, the memory storing instructions that, when executed by the at least one processor, cause the at least one processor to generate at least one high-resolution feature quantity for an input image, generate a low-resolution feature quantity of a lower resolution than the high-resolution feature quantity, selectively execute attention processing on the low-resolution feature quantity, and combine the high-resolution feature quantity and the low-resolution feature quantity, and generate an image to which predetermined image processing has been applied.

Further features of the present invention will become apparent from the following description of exemplary embodiments with reference to the attached drawings.

### BRIEF DESCRIPTION OF THE DRAWINGS

FIG. 1 is a diagram showing a hardware configuration example of an information processing apparatus 100 according to a First Embodiment of the present invention.

FIG. 2 is a functional block diagram showing a configuration example of the information processing apparatus according to the First Embodiment.

FIG. 3 is a flowchart showing an example flow of an information processing method in the information processing apparatus according to the First Embodiment.

FIG. 4 is a functional block diagram showing a configuration example of a neural network according to the First Embodiment.

FIGS. 5A and 5B are functional block diagrams for explaining attention processing according to the First Embodiment.

FIG. 6 is a functional block diagram showing a configuration example of an information processing apparatus according to a Second Embodiment of the present invention.

FIG. 7 is a flowchart showing a processing flow example of an information processing apparatus according to the Second Embodiment.

### DESCRIPTION OF THE EMBODIMENTS

### First Embodiment

Hereinafter, with reference to the accompanying drawings, favorable modes of the present invention will be described using Embodiments. In each diagram, the same reference signs are applied to the same members or elements, and duplicate description will be omitted or simplified.

In a First Embodiment, an information processing apparatus 100 that performs inference processing and learning processing by using a neural network for performing high-quality image processing that improves image quality while suppressing the reduction in processing speed is explained.

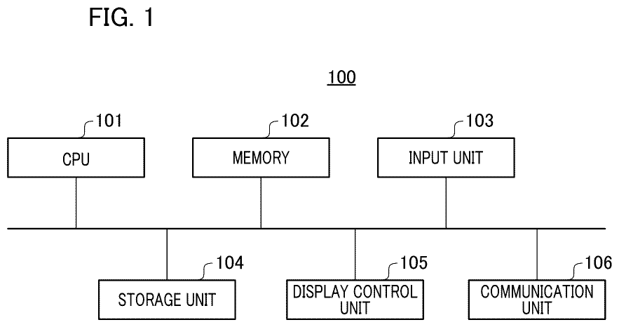

FIG. 1 is a diagram showing a hardware configuration example of the information processing apparatus 100 according to the First Embodiment of the present invention. The information processing apparatus 100 comprises a CPU 101 that serves as a computer, a memory 102 such as RAM and ROM, an input unit 103 such as a keyboard and mouse, and a storage unit 104 that serves as a storage medium for storing computer programs and the like.

In addition, the information processing apparatus 100 is provided with a display control unit 105 that generates display signals for displaying images and the like on a liquid crystal display or organic display, a communication unit 106 for external communication by the information processing apparatus 100, and the like.

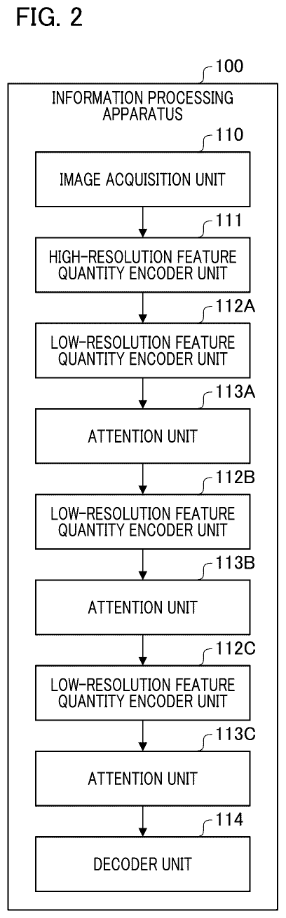

FIG. 2 is a functional block diagram showing a configuration example of an information processing apparatus according to the First Embodiment. It should be noted that a portion of the functional blocks that are shown in FIG. 2 is implemented by causing a CPU or the like serving as a computer (not shown) included in an information processing apparatus to execute a computer program that has been stored in a memory serving as a storage medium (not shown).

However, a portion or all of these may be realized by hardware. As hardware, a dedicated circuit (ASIC), a processor (reconfigurable processor, DSP) and the like can be used.

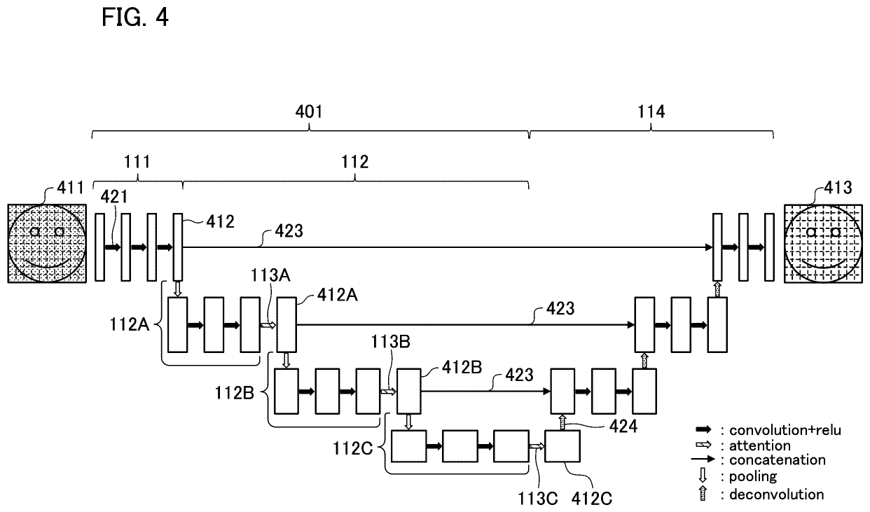

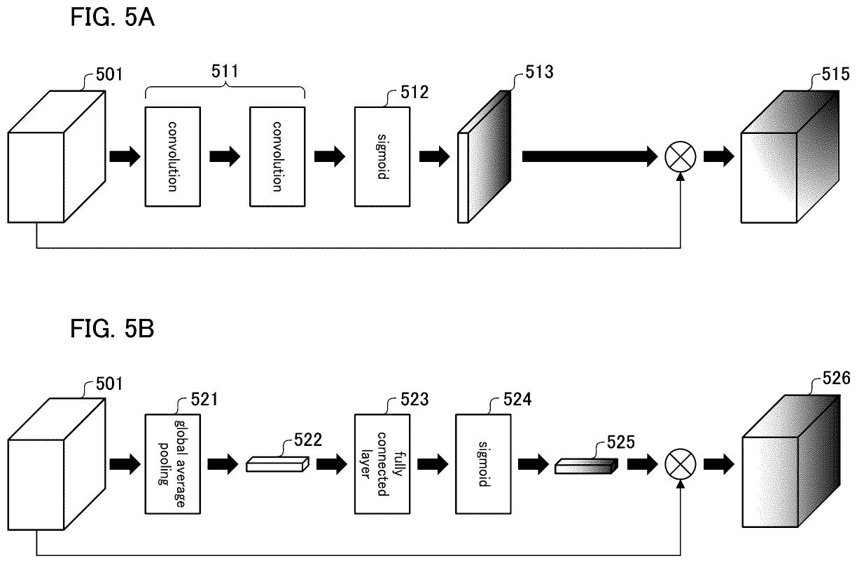

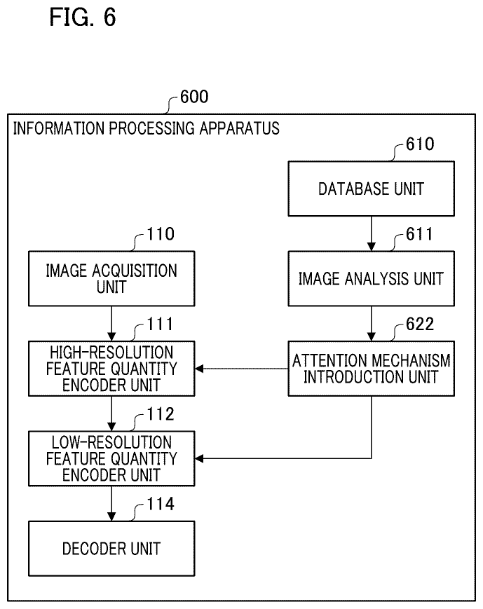

In addition, each of the functional blocks shown in FIG. 2 may be configured by separate devices that are connected to each other via a signal path, without having to be incorporated in the same housing. Note that the above-described explanation regarding FIG. 2 also applies with respect to FIG. 4, FIG. 5, and FIG. 6.

As functional blocks of the neural network, the information processing apparatus 100 is provided with an image acquisition unit 110, a high-resolution feature quantity encoder unit 111, low-resolution feature quantity encoder units 112A to 112C, attention units 113A to 113C, and a decoder unit 114.

The image acquisition unit 110 acquires an input image from an image capturing apparatus, and the high-resolution feature quantity encoder unit 111 generates a high-resolution feature quantity by compressing the input image, and generates at least one high-resolution feature quantity for the input image. The low-resolution feature quantity encoder units 112A to 112C, by compressing the input image, generate low-resolution feature quantities that are of a lower resolution than the feature quantity generated by the high-resolution feature quantity encoder unit 111.

Attention units 113A to 113C execute attention processing on the low-resolution feature quantities. The decoder unit 114 generates an image to which predetermined image processing has been applied by combining the high-resolution feature quantity and the low-resolution feature quantities. It should be noted that, although three each of the low-resolution feature quantity encoder units 112A to 112C and attention units 113A to 113C are provided in the present embodiment, the number is not limited to three.

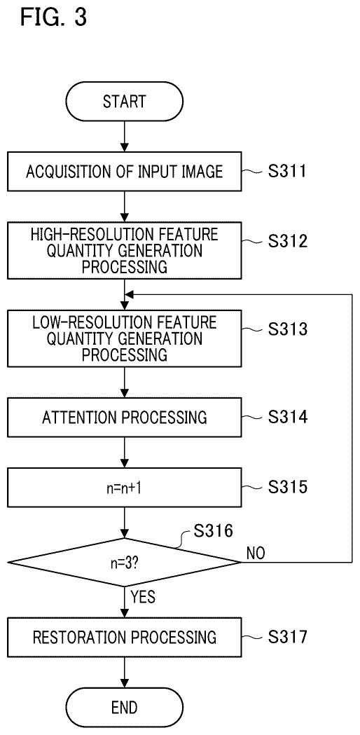

FIG. 3 is a flowchart showing an example flow of an information processing method in the information processing apparatus according to the First Embodiment. It should be noted that the operation of each step in the flowchart of FIG. 3 is sequentially performed by the CPU 101 serving as a computer within the information processing apparatus 100 executing a computer program stored in the storage unit 104.

In addition, FIG. 4 is a functional block diagram showing a configuration example of a neural network according to the First Embodiment. Based on the functional block diagram of FIG. 2, the flowchart of FIG. 3, and the functional block diagram of FIG. 4, inference processing by using the neural network of the information processing apparatus in the present embodiment will be explained.

It should be noted that the neural network according to the present embodiment executes noise removal as high-quality image processing by using a U-Net, as disclosed in Non-Patent Literature 2 (“Toward Convolutional Blind Denoising of Real Photographs”, Shi Guo. 2019). That is, Non-Patent Literature 2 discloses a Convolutional Neural Network (CNN) that implements noise removal, and this CNN is configured by a plurality of convolutional layers and activation layers.

In addition, in the network of Non-Patent Literature 2, noise removal is performed by using a network that is called a U-Net, which has a U-shaped structure, for implementing high-quality image processing, particularly high-quality image processing such as noise removal and super-resolution. In the present embodiment, an example of using the above-described U-Net will be explained.

It should be noted that the neural network according to the present embodiment, as shown in FIG. 4, is divided into an encoder unit 401, which generates feature quantities while compressing the image, and a decoder unit 114, which restores the image from the compressed feature quantities.

First, the encoder unit 401 generates feature quantities of different resolutions and channels of an input image 411. Then, the feature quantities compressed to the end in the encoder unit 401 undergo deconvolution processing in the decoder unit 114, and the feature quantities are restored as an image while reducing the number of channels and increasing the resolution.

Ultimately, it is possible to obtain a denoised image 413 as a high-quality image that has undergone execution of image processing, including predetermined noise removal processing. In the present embodiment, although a network configured as described above is used, any network that implements high-quality image processing and generates feature quantities of multiple resolutions can be employed, regardless of the configuration thereof, and the position and number of attention mechanisms are also not limited thereto.

In step S311 (image acquisition step), the image acquisition unit 110 acquires the input image 411 from an image capturing apparatus and inputs the input image 411 into the high-resolution feature quantity encoder unit 111. In step S312, the input image 411 that was input is subjected to a plurality of convolution processing and Rectified Linear Unit (“ReLU”) activation processing in the high-resolution feature quantity encoder unit 111, by which a high-resolution feature quantity 412 is generated. Here, step S312 functions as a high-resolution feature quantity encoding step that generates at least one high-resolution feature quantity for an input image.

It should be noted that ReLU activation processing is processing that uses a function whereby the output value is always 0 in a case in which the input value is equal to or less than zero, and the output value becomes the same as the input value in a case in which the input value is greater than 0.

In this manner, the network of the present embodiment performs processing 421 that applies a plurality of convolutions and ReLU activation processing to the input image 411 that contains noise, and generates the high-resolution feature quantity 412.

Next, in step S313, the generated feature quantity 412 is input to a low-resolution feature quantity encoder unit 112A and is compressed in the spatial direction by a pooling process to reduce the resolution. In addition, at this time, n is set to 1. Here, step S313 functions as a low-resolution feature quantity encoding step that generates low-resolution feature quantity of a lower resolution than the high-resolution feature quantity.

In the low-resolution feature quantity encoder unit 112A, a feature quantity of a low-resolution is generated by performing a plurality of convolutions and ReLU activation processing on a feature quantity that has been subjected to pooling processing. That is, by repeating convolution and ReLU activation processing again, a feature quantity of a low resolution is obtained.

In step S314, attention processing is executed by an attention unit 113A on the feature quantity generated by the low-resolution feature quantity encoder unit 112. Here, step S314 functions as an attention step that selectively executes attention processing on a feature quantity generated from a low-resolution feature quantity.

After step S314, in step S315, n is incremented by 1, and in step S316, a determination is made as to whether n equals 3. If the determination result is “No”, the processing returns to step S313.

Then, in step S313, a feature quantity 412A in which the attention processing has been executed in the attention unit 113A is further reduced by pooling processing and the feature quantity is compressed in a low-resolution feature quantity encoder unit 112B, as shown in FIG. 4. In addition, a feature quantity 412B is generated by performing attention processing in an attention unit 113B.

Then, the process returns again to step S313 after passing through step S315 and step S316, and in a low-resolution feature quantity encoder unit 112C, the resolution is further reduced by pooling processing, and the feature quantity is compressed. In addition, a feature quantity 412C is generated by performing attention processing in an attention unit 113C.

In this manner, the low-resolution feature quantity encoder unit 112 of the present embodiment has a structure in which attention processing by attention units 113A to 113C is included at the end of the path that generates the feature quantity. It should be noted that the attention processing by attention units 113A to 113C uses attention processing that weights a feature quantity in the spatial direction or attention processing that weights a feature quantity in the channel direction.

FIG. 5 is a functional block diagram for explaining attention processing according to the First Embodiment, and FIG. 5A is a diagram showing an example of attention processing that weights in the spatial direction. Assuming that the size of an input feature quantity 501 is a feature quantity of a height H, a width W, and a channel C, a feature quantity of a height H, a width W, and a channel 1 is generated by performing convolution processing 511 a plurality of times on the input feature quantity 501.

Then, processing 512 that uses a sigmoid function is applied to the generated feature quantity, and a spatial direction weight 513, which holds values between 0 and 1, is generated. In addition, by multiplying the generated weight 513 by the input feature quantity 501, a feature quantity 515 that is weighted in the spatial direction is acquired.

In contrast, FIG. 5B is a diagram showing an example of attention processing that weights in the channel direction. For the input feature quantity 501, global average pooling processing 521 generates a feature quantity 522 of a height 1, a width 1, and a channel C.

The generated feature quantity is further passed through a fully connected layer processing 523, and by applying a sigmoid function 524, a weight 525 of the channel direction is generated. Then, by multiplying the generated weight 525 by the input feature quantity 501, a feature quantity 526 weighted in the channel direction is acquired.

In this manner, the high-resolution feature quantity encoder unit 111 does not incorporate an attention mechanism, and configures a network that selectively executes an attention mechanism (attention processing) only on low-resolution feature quantities. It should be noted that in the present embodiment, the high-resolution feature quantity encoder unit 111 may generate a feature quantity of the largest resolution among a plurality of resolutions of feature quantities generated by the neural network.

In particular, the attention processing of the spatial direction in noise removal processing is less likely to obtain the effect of weighting the feature quantity with respect to the high-resolution feature quantity. This is because attention processing of the spatial direction generates weights by considering the relationship between adjacent elements, but in high-resolution feature quantities, it is difficult to find the relationship between adjacent elements due to noise, and the weights generated by attention processing are difficult to activate. In the present embodiment, by selectively repeating attention processing only on low-resolution feature quantities as described above, it is possible to obtain feature quantities of a plurality of resolutions.

In step S316, when n=3, the process proceeds to step S317, and restoration processing is performed. That is, in step S317, the decoder unit 114 generates a denoised image while skip-connecting feature quantities of a plurality of resolutions.

Here, step S317 functions as a decoding step that combines a high-resolution feature quantity and a low-resolution feature quantity, and generates an image to which predetermined image processing has been applied. The feature quantities compressed to the end in the encoder unit 401 are restored as an image by performing deconvolution processing 424, which is a deconvolution process, while reducing the number of channels and increasing the resolution.

At this time, feature quantities upsampled through deconvolution processing are skip-connected with feature quantities generated by the encoder unit, and multiple convolutions, ReLU processing, and deconvolution processing are repeated. Thereby, it is ultimately possible to output the denoised image 413 having the desired resolution and number of channels.

That is, the feature quantity 412C is upsampled in the decoder unit 114 by deconvolution processing 424, and skip connection (concatenation) processing 423 with the feature quantity 412B is performed.

Then, after a plurality of deconvolution processing and ReLU activation processing are performed, further upsampling and skip connection processing 423 with the feature quantity 412A is performed. Then, after performing a plurality of further deconvolution processing and ReLU activation processing, upsampling is applied, and skip connection processing 423 with the feature quantity 412 is performed. Thereafter, by performing a plurality of further deconvolution processing and ReLU activation processing, it becomes possible to obtain the high-quality denoised image 413 from which noise has been removed.

In this manner, according to the present embodiment, by selectively performing processing-intensive attention processing on low-resolution feature quantities and not performing such processing on high-resolution feature quantities, a reduction in processing speed is suppressed while image quality is improved.

### Second Embodiment

In the First Embodiment, a structure having an attention mechanism selectively in only the low-resolution feature quantity encoder units of a neural network that generates feature quantities of a plurality of resolutions was explained. In the present embodiment, an example in which an attention mechanism is introduced selectively to an encoder unit that analyzes an input image and generates an important (high priority) feature quantity among encoder units having different resolutions will be explained.

FIG. 6 is a functional block diagram showing a configuration example of an information processing apparatus according to a Second Embodiment of the present invention. An information processing apparatus 600 is provided with a database unit 610, an image analysis unit 611, an attention mechanism introduction unit 622, an image acquisition unit 110, the high-resolution feature quantity encoder unit 111, the low-resolution feature quantity encoder unit 112, and the decoder unit 114.

The database unit 610 stores a large number of sets, each including an input image on which image processing is to be executed and a true-value image that is to be restored from the input image. It should be noted that a “true-value image” refers to an image after predetermined image processing is executed on an input image. The image analysis unit 611 analyzes the sets of an input image and a true-value image from the database unit 610, evaluates these sets of the input image and the true-value image, analyzes the images based on the evaluation values, and determines the priority of resolutions for the restoration of the images.

The neural network, consisting of the image acquisition unit 110, the high-resolution feature quantity encoder unit 111, the low-resolution feature quantity encoder unit 112, and the decoder unit 114, generates feature quantities of a plurality of resolutions.

It should be noted that a low-resolution feature quantity encoder unit 112 incorporates, for example, a plurality of low-resolution feature quantity encoder units 112A to 112C and the like as shown in FIG. 2, but these encoder units are omitted in FIG. 6.

The attention mechanism introduction unit 622 introduces an attention mechanism into either the high-resolution feature quantity encoder unit 111 or the low-resolution feature quantity encoder unit 112, based on the analysis results of the image analysis unit 611.

That is, the attention mechanism introduction unit 622 selectively introduces the attention mechanism into an encoder unit that generates feature quantities of a portion of resolutions among a plurality of resolutions, according to the priority of resolutions determined by the image analysis unit. That is, the attention mechanism introduction unit 622 of the present embodiment includes a case in which attention processing is selectively executed on high-resolution feature quantities.

In the present embodiment, an example of performing edge enhancement processing that emphasizes the contours of an image after the execution of super-resolution processing in a neural network will be explained. Edge enhancement processing is processing that emphasizes the edges in an image that are prone to dulling, in the results of image processing such as super-resolution processing and noise removal processing, as disclosed, for example, in Non-Patent Document 3 (“SREdgeNet: Edge Enhanced Single Image Super Resolution using Dense Edge Detection Network and Feature Merge Network”, Kwanyoung Kim. 2018).

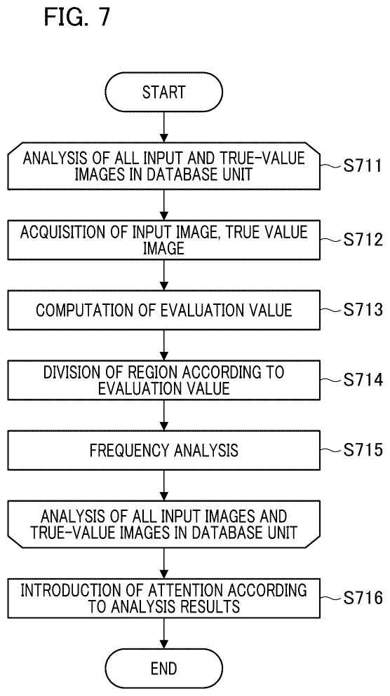

FIG. 7 is a flowchart showing a processing flow example of an information processing apparatus according to the Second Embodiment. It should be noted that the operation of each step of the flowchart of FIG. 7 is sequentially performed by the CPU 101 within the information processing apparatus 100 executing a computer program stored in the storage unit 104.

Step S711 represents the start of a loop process, and the image analysis unit 611 performs an analysis of all sets of input images and true-value images stored in the database unit 610. As described above, the database unit 610 stores sets of input images and true-value images used in the learning and evaluation of the neural network.

In the present embodiment, images having dulled edges relative to the true-value images are used as input images stored in the database unit 610. An image having a dull edge uses an image obtained as a result of super-resolution processing when a certain low-resolution image is input. That is, a true-value image uses a high-resolution image corresponding to a low-resolution image.

In step S712, the image analysis unit 611 acquires a set comprising one input image and one true-value image from the database unit 610. In step S713, an evaluation value is computed by using the input image and the true-value image. In the present embodiment, although the evaluation value uses, for example, an absolute difference value between the input image and the true-value image, the evaluation value may also use, for example, a squared error or the like.

In step S714, the image analysis unit 611 extracts a region from the image for performing analysis according to the evaluation value. That is, from the true-value image, the image analysis unit 611 extracts a region, for example, of a predetermined size and rectangular shape, at a location at which the evaluation value is greater than or equal to a predetermined evaluation threshold.

In step S715, frequency analysis of the rectangular region cut out in step S714 is performed. That is, for example, the difference value between adjacent pixels is calculated, and the variance of the difference value is examined. If the variance is greater than or equal to a predetermined variance threshold, it is determined that the frequency band is a high-frequency band, and if the variance is less than the above-described predetermined variance threshold, it is determined that the frequency band is a low-frequency band. That is, in step S715, frequency analysis of a rectangular region of a predetermined size is performed, and the rectangular region is classified into either a high-frequency band or a low-frequency band.

A region having a large difference value is an important (high priority) region in high-quality image processing, and even in the feature quantities generated within a neural network, emphasizing the information in this region can improve image quality.

In edge enhancement processing, because the evaluation value becomes larger in the vicinity of edges in the image for both the input image and the true-value image, the rectangular region that is cut out is more likely to be classified in the high-frequency band. By performing the processing of step S711 to step S715 in a loop, this processing is applied to all sets of input images and true-value images in the database unit.

In step S716, based on the analysis results by the image analysis unit 611, the attention mechanism introduction unit 622 selectively introduces an attention mechanism (attention processing) into either the high-resolution feature quantity encoder unit 111 or the low-resolution feature quantity encoder unit 112.

That is, in step S715, in a case in which the number of rectangular regions of the high-frequency band is greater than the number of rectangular regions of the low-frequency band, the attention mechanism introduction unit 622 introduces an attention mechanism (attention processing) into the high-resolution feature quantity encoder unit 111. In contrast, in a case in which the number of rectangular regions of the low-frequency band is greater than the number of rectangular regions of the high-frequency band, the attention mechanism introduction unit 622 introduces an attention mechanism (attention processing) into the low-resolution feature quantity encoder unit 112.

That is, based on the comparison results of the number of regions of the high-frequency band and the number of regions of the low-frequency band among the classified rectangular regions, an attention mechanism is introduced into at least one of the high-resolution feature quantity encoder unit and the low-resolution feature quantity encoder unit.

Therefore, in a neural network that executes edge enhancement processing, an attention mechanism is more likely to be introduced into an encoder unit that generates a high-resolution feature quantity.

It should be noted that a weighted attention mechanism (attention processing) may be introduced into both the high-resolution feature quantity encoder unit 111 and the low-resolution feature quantity encoder unit 112. That is, in a case in which the number of rectangular regions in the high-frequency band is greater than the number of rectangular regions in the low-frequency band, more of the attention mechanism (attention processing) may be introduced (weighted) into the high-resolution feature quantity encoder unit 111.

Conversely, in a case in which there are more rectangular regions of the low-frequency band than rectangular regions of the high-frequency band, more of the attention mechanism (attention processing) may be introduced (weighted) into the low-resolution feature quantity encoder unit 112. That is, it is sufficient to introduce the attention mechanism (attention processing) into at least one of the high-resolution feature quantity encoder unit 111 and the low-resolution feature quantity encoder unit 112.

In this manner, according to the present embodiment configured as described above, by focusing the processing-intensive attention processing (so as to increase weighting) on the feature quantities of resolutions having important information in image processing, it is possible to improve image quality performance while suppressing a reduction in processing speed.

It should be noted that in the Second Embodiment, a difference value of the input image and the true-value image was used as the evaluation value, and frequency analysis was performed by extracting important (high priority) regions in high-quality image processing. However, for example, by frequency-transforming a large number of input images or true-value images and taking a statistical quantity thereof, important (high priority) frequency bands in the images may be determined. That is, frequency-transforming may be executed on a plurality of input images or true-value images, and a statistical quantity with respect to the frequency bands of the images may be computed.

Specifically, for example, by executing a Fourier transformation on an input image and obtaining the Fourier transformation result, the intensity of each frequency in the image can be computed. Then, the variance value of the intensity of each frequency is calculated, and this calculation is performed on the Fourier transformation results of numerous input images, followed by taking the average value of these variance values. That is, as a statistical quantity, the average value of the variance of the intensity of each frequency band of a plurality of images is used.

At this time, if the variance value is greater than a certain threshold, it is determined that the distribution of the input image is important (of high priority) in the high-frequency band, and more of an attention mechanism may be introduced into the high-resolution feature quantity encoder unit.

In contrast, if the variance value is smaller than the above-described threshold, it is determined that the low-frequency band is important (of higher priority), and more of an attention mechanism may be introduced into the low-resolution feature quantity encoder unit. In this manner, based on the statistical quantity, an attention mechanism may be introduced into at least one of a high-resolution feature quantity encoder unit and a low-resolution feature quantity encoder unit.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present invention.

Furthermore, the present invention includes, for example, at least one processor or circuit configured to perform the functions of the embodiments described above. It should be noted that a plurality of processors may be used to implement distributed processing.

This application claims the benefit of priority from Japanese Patent Application No. 2023-067793, filed on Apr. 18, 2023, which is hereby incorporated by reference herein in its entirety.

What is claimed is:

1. An information processing apparatus, comprising:
at least one processor; and
a memory coupled to the at least one processor, the memory storing instructions that, when executed by the at least one processor, cause the at least one processor to:
generate at least one high-resolution feature quantity for an input image;
generate a low-resolution feature quantity of a lower resolution than the high-resolution feature quantity;
selectively execute attention processing on the low-resolution feature quantity; and
combine the high-resolution feature quantity and the low-resolution feature quantity, and generate an image to which predetermined image processing has been applied.

2. The information processing apparatus according to claim 1, wherein when generating the high-resolution feature quantity, a feature quantity of the largest resolution among a plurality of resolutions of feature quantities is generated.

3. The information processing apparatus according to claim 1, wherein in the attention processing, attention processing that weights the input feature quantities in the spatial direction is executed.

4. The information processing apparatus according to claim 1, wherein the instructions are executed by using neural network.

5. The information processing apparatus according to claim 1, wherein the predetermined image processing is configured to include noise removal processing.

6. An information processing apparatus, comprising:
at least one processor; and
a memory coupled to the at least one processor, the memory storing instructions that, when executed by the at least one processor, cause the at least one processor to:
generate at least one high-resolution feature quantity for an input image;
generate a low-resolution feature quantity of a lower resolution than the high-resolution feature quantity;
selectively execute attention processing on the high-resolution feature quantity; and
combine the high-resolution feature quantity and the low-resolution feature quantity, and generate an image to which predetermined image processing has been applied.

7. An information processing apparatus, comprising:
at least one processor; and a memory coupled to the at least one processor, the memory storing instructions that, when executed by the at least one processor, cause the at least one processor to:
analyze an input image and determine the priority of resolutions for the restoration of the image; and
according to the priority, introduce an attention mechanism when generating feature quantities of a portion of resolutions among a plurality of resolutions.

8. The information processing apparatus according to claim 7, wherein the memory stores further instructions that, when executed by the at least one processor, cause the at least one processor to:
store sets of the input image and the true-value image that is to be restored from the input image; and
when performing the analysis of the image, evaluate the sets of the input image and the true-value image, then analyze the image based on the evaluation values, and determine the priority.

9. The information processing apparatus according to claim 8, wherein in analysis of the image, a difference value of the input image and the true-value image is used as the evaluation value.

10. The information processing apparatus according to claim 8, wherein in the analysis of the image, a region of a predetermined size is cut out from the true-value image at a location at which the evaluation value is greater than or equal to a predetermined threshold.

11. The information processing apparatus according to claim 10, wherein in analysis of the image, frequency analysis is performed on the region of the predetermined size, and the region is classified into either a high-frequency band or a low-frequency band.

12. The information processing apparatus according to claim 11, wherein when introducing the attention mechanism, the attention mechanism is introduced into at least one of the encoding of high-resolution feature quantities and the encoding of low-resolution feature quantities, based on the comparison results of the number of regions of the high-frequency band and the number of regions of the low-frequency band within the classified region.

13. The information processing apparatus according to claim 8, wherein in analysis of the image, frequency-transforming is executed on a plurality of the input images or the true-value images, and a statistical quantity with respect to the frequency bands of the images is computed.

14. The information processing apparatus according to claim 13, wherein the statistical quantity is the average value of the variance of the intensity of each frequency band of a plurality of images.

15. The information processing apparatus according to claim 13, wherein when introducing the attention mechanism, an attention mechanism is introduced into at least one of the encoding of high-resolution feature quantities and the encoding of low-resolution feature quantities, according to the statistical quantity.

16. An information processing method for a neural network comprising:
image acquiring to acquire an input image;
high-resolution feature quantity encoding to generate at least one high-resolution feature quantity for the input image;
low-resolution feature quantity encoding to generate a low-resolution feature quantity of a lower resolution than the high-resolution feature quantity;
attention processing to selectively execute attention processing on the low-resolution feature quantity; and
decoding to combine the high-resolution feature quantity and the low-resolution feature quantity, and generate an image to which predetermined image processing has been applied.

17. A non-transitory computer-readable storage medium configured to store a computer program comprising instructions for executing the following processes:
image acquiring to acquire an input image;
high-resolution feature quantity encoding to generate at least one high-resolution feature quantity for the input image;
low-resolution feature quantity encoding to generate a low-resolution feature quantity of a lower resolution than the high-resolution feature quantity;
attention processing to selectively execute attention processing on the low-resolution feature quantity; and
decoding to combine the high-resolution feature quantity and the low-resolution feature quantity, and generate an image to which predetermined image processing has been applied.
